(19) United States
(12) Patent Application Publication
(10) Pub. No.: US 2013/0243555 A1
(43) Pub. Date: Sep. 19, 2013

(54) Box Lifting Assembly for Dump Trucks or Similar Vehicles

(71) Applicants: Claude Boivin, Levis (CA); Bruno Lechance, Saint-Etienne-de-Lauzon (CA); Martial Guyot, Belverne (FR)

(72) Inventors: Claude Boivin, Levis (CA); Bruno Lechance, Saint-Etienne-de-Lauzon (CA); Martial Guyot, Belverne (FR)

(73) Assignee: Groupe Environnemental Labrie Inc., Saint-Nicolas, QC (CA)

(21) Appl. No.: 13/988,383

(22) PCT Filed: Nov. 21, 2011
(86) PCT No.: PCT/IB11/55222

§ 371 Date: May 20, 2013

Related U.S. Application Data
(60) Provisional application No. 61/416,131, filed on Nov. 22, 2010.

(51) Int. Cl. B60P 1/04

(52) U.S. Cl. CPC B60P 1/04
USPC 414/546; 414/539; 414/812

(57) ABSTRACT

There is provided a lifting assembly for selectively loading a container onto a chassis of a vehicle and unloading the container from the chassis, the lifting assembly comprising: a frame connected to the chassis; an arm having a first end pivotably connected to the frame and a second end releasably connectable to the container; and a pivoting actuator having a first actuator portion pivotably connected to the frame and a second actuator portion pivotably connected to the arm between the first and second ends thereof, the second actuator portion being linearly movable relative to the first actuator portion for pivoting the arm relative to the frame to selectively move the container towards the frame and away from the frame. There is further provided a cargo-carrying vehicle comprising the lifting assembly and a method for unloading a container mounted on a chassis of a vehicle from the vehicle.

### CROSS-REFERENCE TO RELATED APPLICATIONS

This application claims priority under 35USC§119(e) of U.S. provisional patent application 61/416,131 filed Nov. 22, 2010, the specification of which is hereby incorporated by reference.

### TECHNICAL FIELD

The invention relates to box lifting assemblies for dump trucks or similar vehicles. More precisely, the invention pertains to lifting assemblies for selectively loading a box onto a chassis of a vehicle and unloading the box from the chassis. The invention also pertains to a cargo-carrying vehicle provided with a lifting assembly and to a method for unloading a container mounted on a chassis of a vehicle from the vehicle.

### BACKGROUND

Dump trucks are widely used for transporting loose material for construction, goods or waste. Usually, a dump truck has a chassis and a rear container, or box, which is tiltable, most often rearwardly, to allow the transported material to be dumped at a desired site through a rear opening.

It may be advantageous to transport the content of the box from one site to another. For instance, if the dump truck transports waste, it may be desirable to transport the waste to a disposal site such as a landfill or the like, which may be far away from the waste collection site or sites.

Unfortunately, such trucks are usually not adapted to travel great distances. They are therefore unpractical for transporting material from one site to another when the two sites are far apart. Moving the dump truck away from the collection site for extended periods of time may further be costly and may decrease productivity.

### SUMMARY

According to one aspect, there is provided a lifting assembly for selectively loading a container onto a chassis of a vehicle and unloading the container from the chassis, the lifting assembly comprising: a frame connected to the chassis; an arm having a first end pivotably connected to the frame and a second end releasably connectable to the container; and a pivoting actuator having a first actuator portion pivotably connected to the frame and a second actuator portion pivotably connected to the arm between the first and second ends thereof, the second actuator portion being linearly movable relative to the first actuator portion for pivoting the arm relative to the frame to selectively move the container towards the frame and away from the frame.

In one embodiment, the frame is pivotably connected to the chassis.

In one embodiment, the lifting assembly further comprises a frame actuator pivotably connected to the chassis and to the frame for tilting the frame rearwardly relative to the chassis.

In one embodiment, the arm comprises an arm actuator having a first actuator portion located near the first end of the arm and a second actuator portion located near the second end of the arm, the first actuator portion being movable relative to the second actuator portion to allow the container to be selectively moved frontwardly and rearwardly relative to the frame.

In one embodiment, the arm actuator is a linear actuator.

In one embodiment, the arm actuator is a hydraulic cylinder.

In one embodiment, the arm comprises: a first link member pivotably connected to the frame; and a second link member pivotably connected to the first link member, the second link member being releasably connected to a front end of the container.

In one embodiment, the arm is movable between a folded position wherein the second link member is pivoted rearwardly relative to the first link member to form an angle therewith, and an unfolded position wherein the second link member is parallel to the first link member.

In one embodiment, the first link member is pivotable rearwardly relative to the frame to enable locating the second end of the arm rearwardly of the frame and orienting the second end of the arm towards a ground surface when the arm is in the folded position.

In one embodiment, the second link member is extendable for placing the front end of the container on the ground surface when the second end of the arm is located rearwardly of the frame and oriented towards the ground.

In one embodiment, the pivoting actuator is a linear actuator.

In one embodiment, the pivoting actuator is a hydraulic cylinder.

According to another aspect, there is also provided a cargo-carrying vehicle comprising: a container; a chassis for receiving the container thereon; and a lifting assembly for selectively loading the container onto the chassis and unloading the container from the chassis, the lifting assembly including: a frame connected to the chassis; an arm having a first end pivotably connected to the frame and a second end releasably connected to the container; and a pivoting actuator having a first actuator portion pivotably connected to the frame and a second actuator portion pivotably connected to the arm between the first and second ends thereof, the second actuator portion being linearly movable relative to the first actuator portion for pivoting the arm relative to the frame to selectively move the container towards the frame and away from the frame.

In one embodiment, the frame is pivotably connected to the chassis.

In one embodiment, the vehicle further comprises a frame actuator pivotably connected to the chassis and to the frame for tilting the frame rearwardly relative to the chassis.

According to yet another aspect, there is also provided a method for unloading a container mounted on a chassis of a vehicle from the vehicle, the method comprising: providing a lifting assembly comprising a frame connected to the chassis for supporting the container, and an arm having a first end pivotably connected to the frame and a second end releasably connected to a front end of the container; moving the container rearwardly to locate a rear end of the container rearwardly from the frame; pivoting the arm rearwardly until the front end of the container is located rearwardly from the frame; releasing the container from the arm.

In one embodiment, the arm comprises: a first link member pivotably connected to the frame; and a second link member pivotably connected to the first link member, the second link member being releasably connected to a front end of the container.

In one embodiment, the method further comprises: after pivoting the arm rearwardly, extending the second link member until the front end of the container abuts a ground surface.

In one embodiment, moving the container rearwardly comprises: placing the arm in an unfolded position wherein the second link member is parallel to the first link member and to the frame; retracting the second link member.

In one embodiment, the frame is pivotably connected to the chassis, and the method further comprises: tilting the frame rearwardly relative to the chassis to tilt the container rearwardly.

### BRIEF DESCRIPTION OF THE DRAWINGS

In order that the invention may be readily understood, embodiments of the invention are illustrated by way of example in the accompanying drawings.

FIG. 1 is a schematic drawing showing a side elevation view of a dump truck having a box connected thereto via a lifting assembly, in accordance with one embodiment, with the lifting assembly in the transport position.

FIG. 2 is a drawing showing a side elevation view of the dump truck shown in FIG. 1, with the box removed therefrom and the lifting assembly deployed to show details thereof.

FIG. 3 is a drawing showing a side elevation view of the dump truck shown in FIG. 1, with the frame tilted rearwardly.

FIG. 4 is a drawing showing a side elevation view of the dump truck shown in FIG. 1, with the frame tilted rearwardly and the box spaced from the hopper.

FIG. 5 is a drawing showing a side elevation view of the dump truck shown in FIG. 1, with the frame tilted rearwardly and the pivoting actuator slightly extended to pivot the arm rearwardly.

FIG. 6A is a drawing showing a side elevation view of the dump truck shown in FIG. 1, with the frame tilted rearwardly and the pivoting actuator further extended to further pivot the arm rearwardly and to thereby move the box away from the chassis.

FIG. 6B is a drawing showing a side elevation view of the dump truck shown in FIG. 1, with the pivoting actuator further extended and the whole arm pivoted rearwardly.

FIG. 7 is a drawing showing a side elevation view of the dump truck shown in FIG. 1, with the lifting assembly deployed, the second link extended and the box resting on the ground surface.

FIG. 8A is a drawing showing a side elevation view of the dump truck shown in FIG. 1, with the box resting on the ground near the deployed lifting assembly and detached therefrom.

FIG. 8B is a drawing showing a side elevation view of a dump truck in accordance with an alternative embodiment in which the length of the frame is different than in FIG. 8A, with the box resting on the ground near the deployed lifting assembly and detached therefrom.

FIG. 9 is a drawing showing a side elevation view of a dump truck having a box connected thereto via a lifting assembly, in accordance with yet another embodiment, with the frame spaced from the hopper and tilted rearwardly.

FIG. 10 is a drawing showing a side elevation view of the dump truck shown in FIG. 9, with the arm member pivoted rearwardly to thereby move the box away from the frame.

FIG. 11 is a drawing showing a side elevation view of the dump truck shown in FIG. 9, with the frame actuator extended to further pivot the arm member rearwardly.

FIG. 12 is a drawing showing a side elevation view of the dump truck shown in FIG. 9, with the arm actuator extended to lower the front end of the box towards the ground surface.

FIG. 13 is a drawing showing a side elevation view of the dump truck shown in FIG. 9, with the frame spaced from the hopper and the frame actuator extended to tilt the frame rearwardly in order to position the wheels of the box onto an elevated receiving surface.

FIG. 14 is a drawing showing a side elevation view of the dump truck shown in FIG. 9, with the pivoting actuator extended to pivot the arm member rearwardly until the box rests generally horizontally on the elevated receiving surface.

FIG. 15 is a drawing showing a side elevation view of a trailer coupled to a tractor unit, in accordance with one embodiment, with a plurality of boxes positioned on the trailer.

FIG. 16 is a drawing showing a side elevation view of a dump truck in accordance with yet another embodiment, coupled to a trailer on which a box is received.

FIG. 17 is a drawing showing a side elevation view of a dump truck in accordance with yet another embodiment, coupled to a trailer on which a plurality of boxes are received.

FIG. 18 is a drawing showing a side elevation view of a dump truck, in accordance with yet another embodiment, with the lifting assembly in the transport position.

FIG. 19 is a drawing showing a side elevation view of the dump truck shown in FIG. 18, with the box moved rearwardly and spaced from the hopper.

FIG. 20 is a drawing showing a side elevation view of the dump truck shown in FIG. 18, with the pivoting actuator extended to pivot the arm rearwardly.

FIG. 21 is a drawing showing a side elevation view of the dump truck shown in FIG. 18, with the pivoting actuator further extended to further pivot the arm rearwardly.

FIG. 22 is a drawing showing a side elevation view of the dump truck shown in FIG. 18, with the pivoting actuator further extended and the whole arm pivoted rearwardly.

FIG. 23 is a drawing showing a side elevation view of the dump truck shown in FIG. 18, with the pivoting actuator extended as shown in FIG. 22 and with the arm actuator partially extended.

FIG. 24 is a drawing showing a side elevation view of the dump truck shown in FIG. 18, with the pivoting actuator and the arm actuator further extended such that the front end of the box abuts the ground surface.

FIG. 25 is a drawing showing a side elevation view of the dump truck shown in FIG. 18, with the box resting on the ground near the deployed lifting assembly and detached therefrom.

It will be noted that throughout the appended drawings, like features are identified by like reference numerals.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

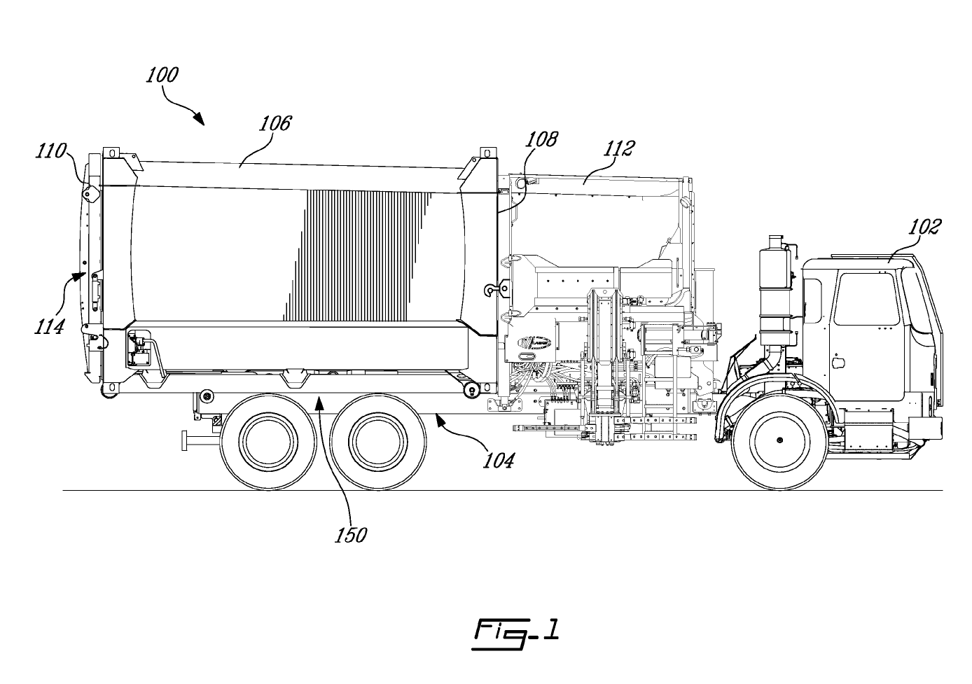

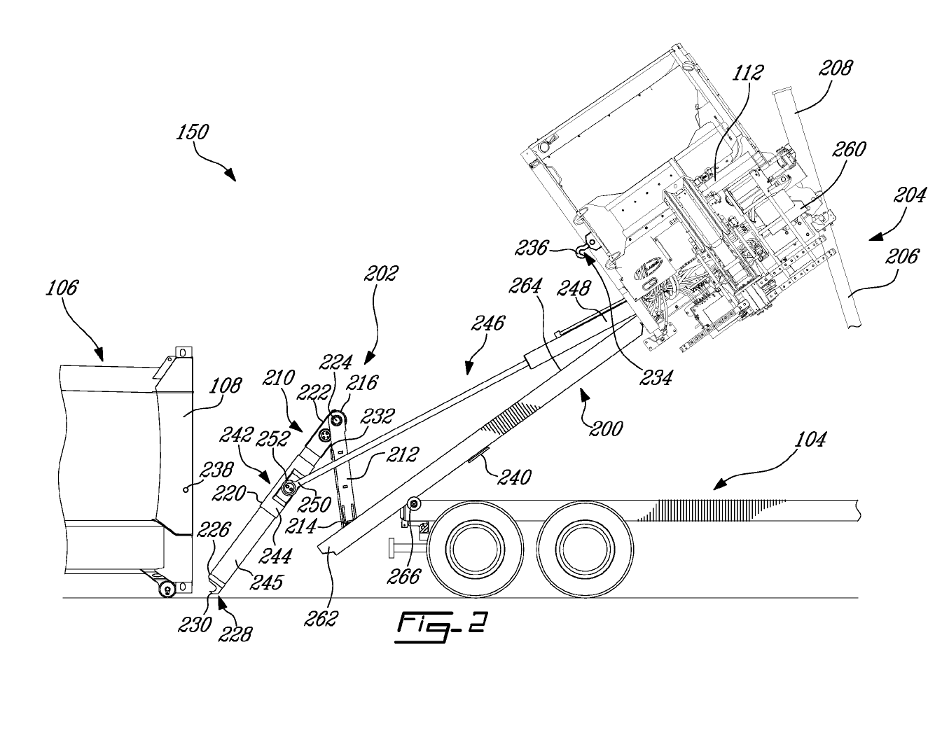

Referring to FIGS. 1 and 2, there is provided a dump truck 100 comprising a cab 102 and a chassis 104. In the illustrated embodiment, the dump truck 100 further comprises a container or box 106 having a front end 108 and a rear end 110, and a hopper 112 mounted on the chassis 104 between the cab 102 and the box 106. The box 106 may be of the type known in the art and may comprise a rear door 114 to allow unloading of loose material, such as material used for construction, goods or waste therethrough.

The box 106 and the hopper 112 are connected to the chassis 104 via a lifting assembly 150 which allows the box 106 to be selectively loaded onto the chassis 104 and unloaded from the chassis 104. More specifically, the lifting assembly 150 comprises a frame 200 connected to the chassis 104 and adapted for resting on the chassis 104, and an actuating assembly 202 for tilting the frame 200 and moving the box 106 relative to the frame 200.

In the embodiment illustrated in FIGS. 1 and 2, the frame 200 has a front end 260, a rear end 262 and an upper receiving surface 264 extending between the front end 260 and the rear end 262 for receiving the box 106 thereon. The hopper 112 is located at the front end 260 of the frame 200 and is secured thereto. The rear end 262 is pivotably connected to the chassis 104 via a rear pivoting axle 266 to allow the frame 200 to be tilted rearwardly, as will be further appreciated below.

Still in the illustrated embodiment, the actuating assembly 202 comprises a first linear actuator, or frame actuator 204, for tilting the frame 200 rearwardly. More specifically, the frame actuator 204 has a first portion 206 pivotably connected to the chassis 104 and a second portion 208 pivotably connected the front end 260 of the frame 200. The first portion 206 is telescopically movable relative to the second portion 208. In a first or transport position, in which the frame 200 rests on the chassis 104, the frame actuator 204 is retracted. When the frame actuator 204 is extended, the front end 260 of the frame 200 is moved upwardly, away from the chassis 104, and the frame 200 is pivoted relative to the chassis 104 about its rear end 262. This configuration allows the dump truck 100 provided with the lifting assembly 150 described herein to function as a regular dump truck, as one skilled in the art will appreciate.

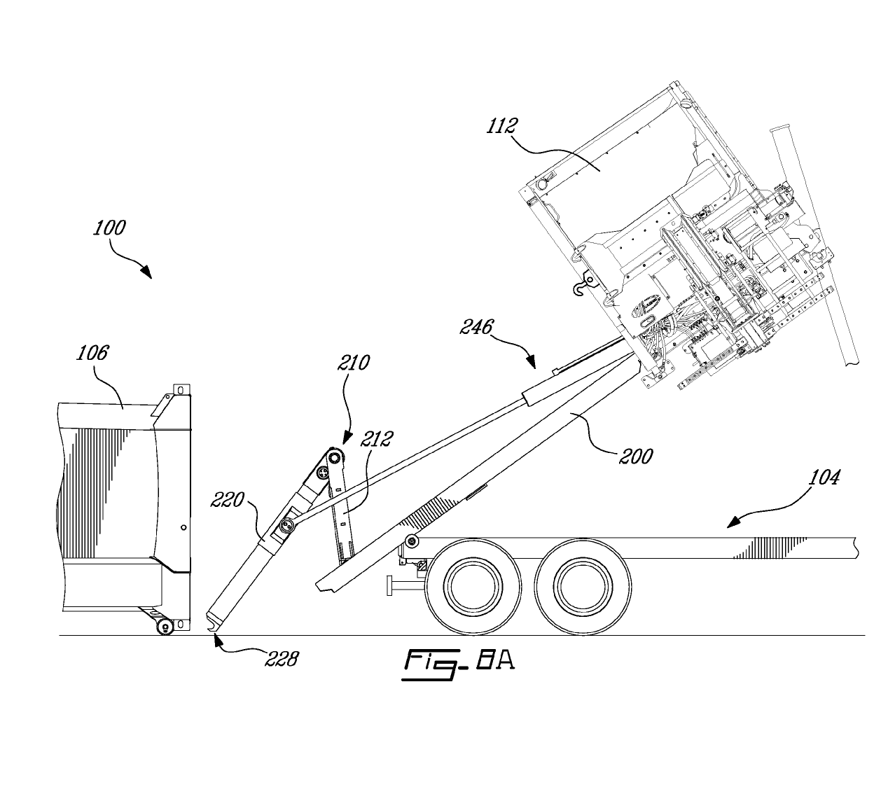

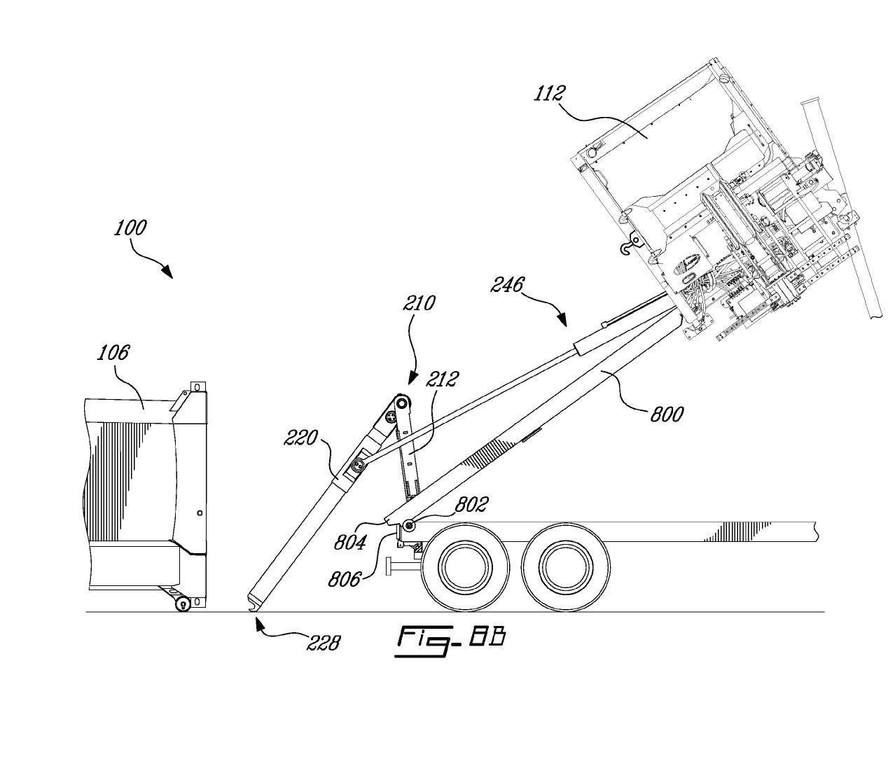

In the embodiment illustrated in FIGS. 1 to 8A, the rear pivoting axle 266 connecting the frame 200 to the chassis 104 is not located at the rear end 262 of the frame 200, but is instead spaced from the rear end 262 of the frame 200. More specifically, the frame 200 is longer than the chassis 104 and sticks out rearwardly from the chassis 200 when the frame 200 rests on the chassis 104. In an alternative embodiment shown in FIG. 8B, the dump truck 100 comprises a frame 800 pivotably connected to the chassis 104 via a rear pivoting axle 802 which is located substantially at a rear end 804 of the frame 800. In this configuration, when the frame 800 rests on the chassis 104 in the transport position, the rear end 804 of the frame 800 is substantially vertically aligned with a rear end 806 of the chassis 104. It will be appreciated that in yet another embodiment, the rear pivoting axle may instead be positioned along the frame at an alternative position which the skilled addressee may deem suitable in order to allow the frame to be tilted rearwardly relative to the chassis 104.

Referring back to FIGS. 1 and 2, the actuating assembly 202 further comprises an arm 210 removably connecting the box 106 to the frame 200. In one embodiment, the arm 210 is articulated and comprises a first link member 212 having a first end 214 pivotably connected to the frame 200 via an arm pivoting axle, not shown, and a second end 216. The arm 210 further comprises a second link member 220 having a first end 222 pivotably connected to the second end 216 of the first link member 212 via an arm pivot 224 and a second end 226 releasably connected to the front end 108 of the box 106 via a box attachment member 228. Since the arm 210 is articulated, it may be moved between an unfolded position in which the second link member 220 is parallel to the first link member 212, as shown in FIGS. 1, 3 and 4, and a folded position in which the second link member 220 is pivoted rearwardly relative to the first link member 212 to form an angle with the first link member 212, as shown in FIGS. 2 and 5 to 8A.

In one embodiment, the box attachment member 228 comprises a hook member 230 configured to allow the box 106 to be relatively easily detached from the arm 210 when the box 106 is unloaded from the dump truck 100 and rests on a receiving surface, such as a ground surface, as will become apparent below. Alternatively, the box attachment member 228 may comprise a hook-and-latch mechanism manually operable by a user to allow the user to manually detach the box 106 from the arm 210 once the box 106 has been unloaded from the dump truck 100 and rests on the ground surface.

In the illustrated embodiment, the first link member 212 further comprises an abutment portion 232 located proximal to the arm pivot 224. The abutment portion 232 is positioned to prevent the second link member 220 from being completely folded against the first link member 212 in a jackknife-like fashion.

In one embodiment, a stop member 240 is further secured to the frame 200, below the first link member 212 of the arm 210, to allow the first link member 212 to abut thereagainst in order to prevent it from pivoting below the frame 200, as will be further explained below.

In the illustrated embodiment, the second link member 220 is a second linear actuator, or arm actuator 242, and comprises an actuator sleeve 244 an elongated inner member 245 telescopically engaged in the actuator sleeve 244 and linearly movable relative thereto.

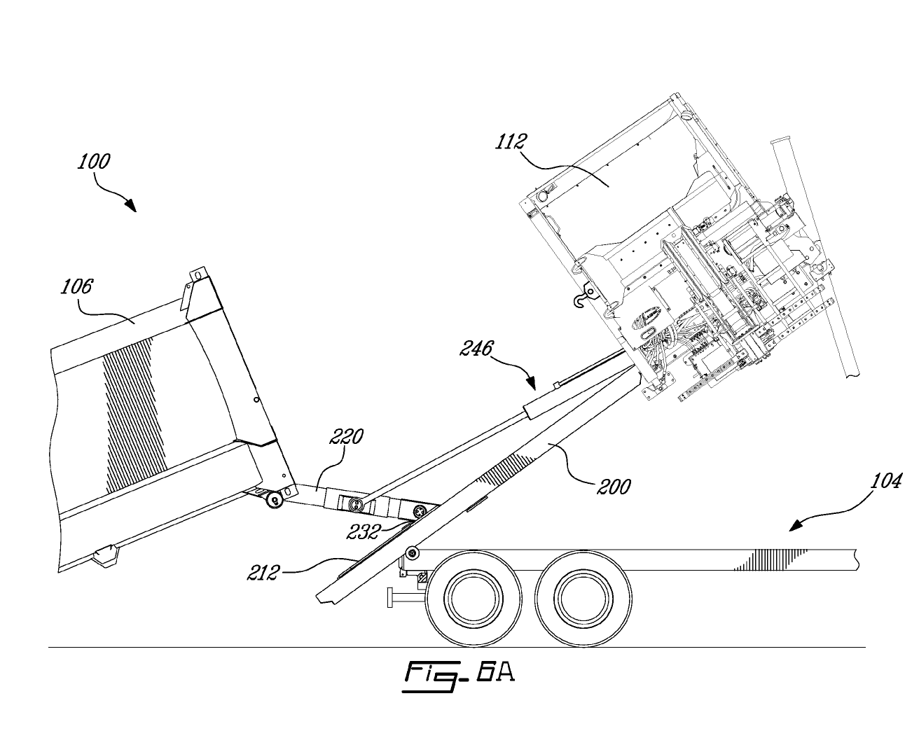

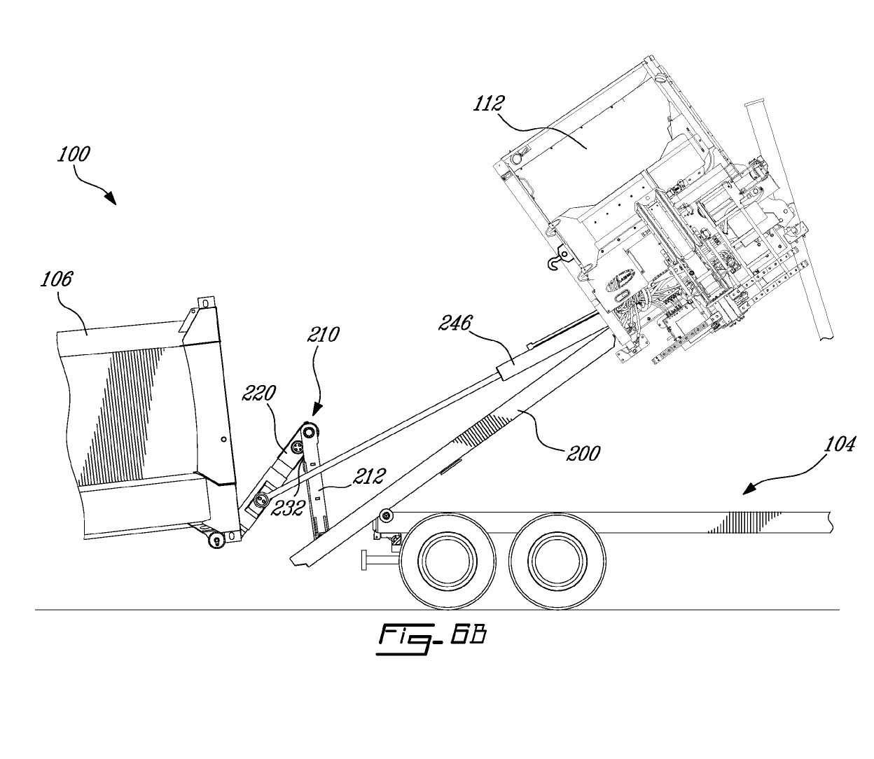

The actuating assembly 202 further comprises a third linear actuator, or pivoting actuator 246, for pivoting the arm 210 relative to the frame 200. The pivoting actuator 246 comprises a first or front end 248 pivotably connected to the frame 200, near the hopper 112 thereof, and a second or rear end 250 pivotably connected to the actuator sleeve 244 of the arm actuator 242 via an intermediate pivot 252. When the pivoting actuator 246 is extended, it allows the arm 210 to be first positioned in the folded position. By further extending the pivoting actuator 246, the arm 210 may be positioned such that the second end 226 of the second link member 220, releasably connected to the front end 108 of the box 106, is located rearwardly of the frame 200, as shown in FIG. 6B. In this configuration, the frame 200 is no longer under the box 106, to allow the box 106 to be lowered towards the ground surface.

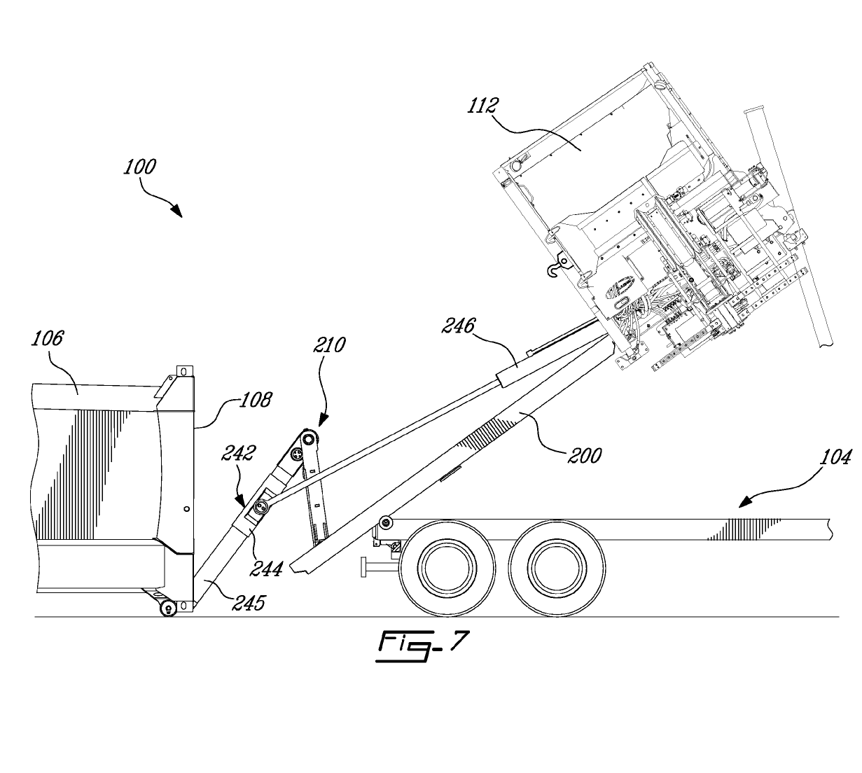

Furthermore, still in this configuration, the second end 226 of the second link member 220 is also oriented towards the ground surface, as further shown in FIG. 6B. This allows the front end 108 of the box 106 to be lowered onto the ground surface by extending the arm actuator 242 until the front end 108 of the box 106 abuts the ground surface, as shown in FIG. 7.

In one embodiment, the frame actuator 204, the arm actuator 242 and the pivoting actuator 246 all comprise hydraulic actuators, which allow a relatively precise control of the speed of each movement, while allowing for boxes containing heavy loads to be moved. Alternatively, the frame actuator 204, the arm actuator 242 and the pivoting actuator 246 may instead comprise any other type of linear actuators deemed suitable by the skilled addressee, such as pneumatic actuators and the like.

A connecting device 234 may further be provided for releasably connecting the box 106 to the hopper 112 to selectively prevent the box 106 from moving relative to the hopper 112 during tilting of the frame 200, or during the collection and/or transportation of the contents by the truck as will become apparent below. In the illustrated embodiment, the connecting device 234 comprises a hook member 236 configured to selectively engage a latch member 238 secured to the box 106. The hook member 236 may be pivotably, linearly, or otherwise connected to the hopper 112 by a rotary, linear, sliding or other actuator to allow the box 106 to be remotely detached from the hopper 112, as will be further explained below.

In one embodiment, the lifting assembly 150 further comprises a controller operatively connected to the connecting device 234, to the frame actuator 204, to the arm actuator 242 and to the pivoting actuator 246 to allow the lifting assembly 150 to be operated remotely by the user. For instance, the controller may be located inside the cab 102 of the dump truck 100 to allow a driver of the dump truck 100 to selectively load the box 106 onto the frame 200 and unload the box 106 from the frame 200 without having to exit the cab 102. Alternatively, the controller may be accessible from outside the dump truck 100 and be operable by a user standing next to the dump truck 100.

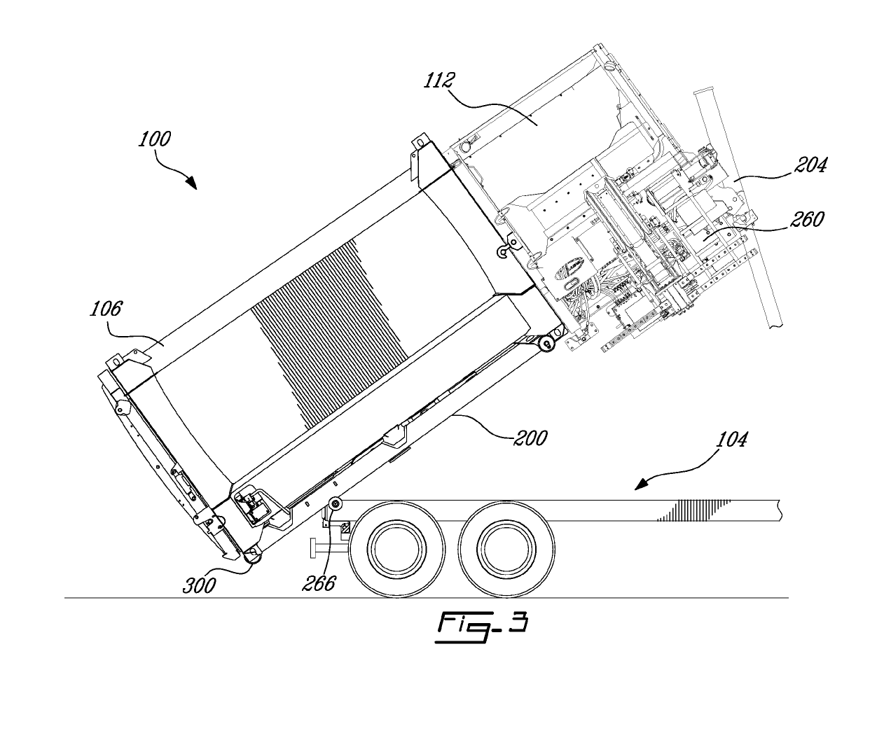

With reference to FIGS. 3 to 8A, the operation of unloading the box 106 from the dump truck 100 using the lifting assembly 150 will now be described, in accordance with one embodiment.

In a starting or transport position, the frame actuator 204 is retracted such that the frame 200 rests on the chassis 104, generally horizontally, and the box 106 rests on the frame 200. The arm 210 is unfolded and extends along the frame 200. The arm actuator 242 is in an extended position and the pivoting actuator 246 is in a retracted position such that the second end 226 of the second link member 220 is located proximal to the hopper 112, with the box attachment member 228 engaging the box 106. In this position, the box 106 is positioned adjacent the hopper 112, and the connecting device 234 connects the box 106 to the hopper 112.

According to one step illustrated in FIG. 3, the frame actuator 204 is extended to move the front end 260 of the frame 200 upwardly in order to pivot the frame 200 about the rear pivoting axle 266, thereby tilting the frame 200 rearwardly.

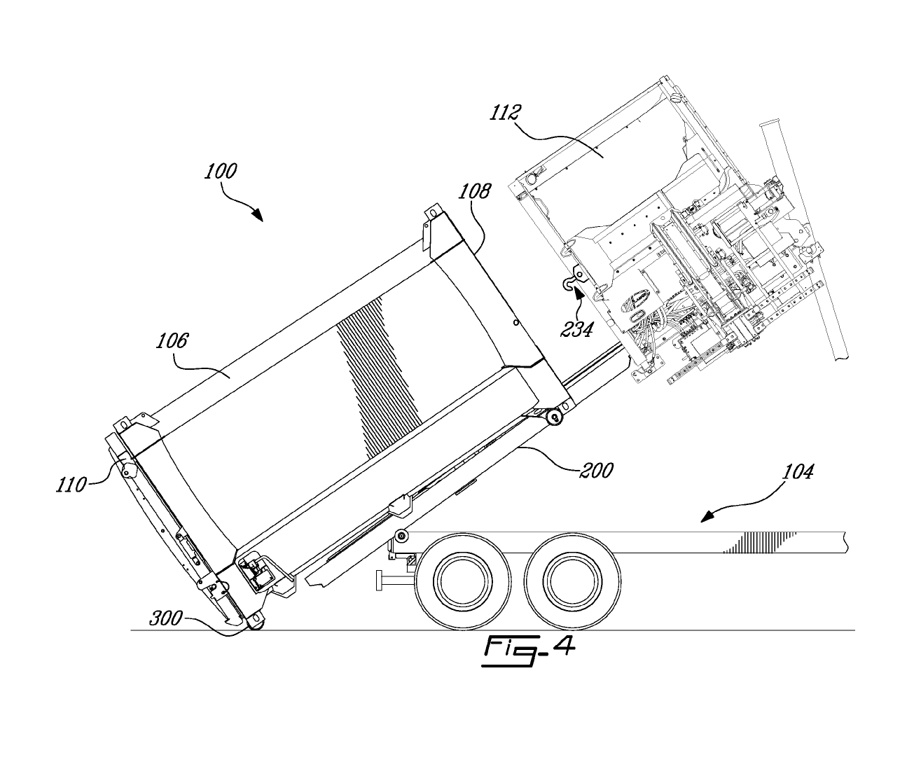

According to another step illustrated in FIG. 4, the connecting device 234 is disconnected to release the box 106 from the hopper 112. The arm actuator 242 is then retracted to move the box 106 rearwardly, in order to locate the rear end 110 of the box 106 rearwardly from the rear end 262 of the frame 200. The box 106 is thereby moved rearwardly until the box 106 contacts the ground surface. In one embodiment, the box 106 comprises a plurality of wheels 300 rotatably mounted to the rear end 110 thereof for facilitating movement of the rear end 110 of the box 106 on the ground surface during loading of the box 106 onto the dump truck 100 and unloading of the box 106 from the dump truck 100. In this embodiment, the arm actuator 242 is retracted until the plurality of wheels 300 contact the ground surface or until the actuator reaches the end of its actuation path.

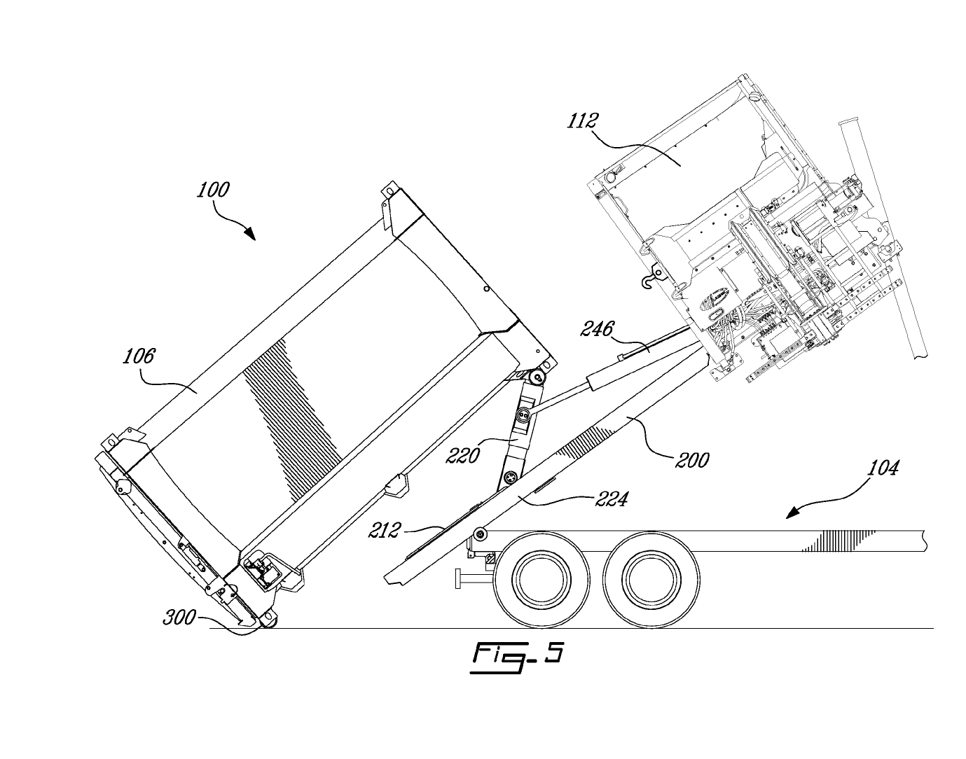

According to another step illustrated in FIG. 5, the pivoting actuator 246 is extended to pivot the second link member 220 about the arm pivot 224 until the second link member 220 abuts the abutment portion 232 of the first link member 212. During this step, the arm 210 is therefore moved from the unfolded position into the folded position.

According to yet another step illustrated in FIGS. 6A and 6B, the pivoting actuator 246 is further extended. Since the second link member 220 abuts the abutment portion 232 of the first link member 212, the second link member 220 is prevented from further pivoting about the arm pivot 224. Instead, the whole arm 210, including the first and second link members 212, 220, pivots about the arm pivoting axle which connects the first link member 212 to the frame 200. In this step, as the arm 210 pivots, the box 106 is lowered towards the ground surface while the first link member 212 is angled away from the frame 200. As explained above, the second end 226 of the second link member 220 is now located rearwardly of the frame 200, such that the frame 200 is no longer under the box 106.

According to yet another step illustrated in FIG. 7, the arm actuator 242 is extended such that the elongated inner member 245 moves away from the actuator sleeve 244 to move the front end 108 of the box 106 towards the ground surface until the box 106 rests on the ground surface, generally horizontally.

According to yet another step illustrated in FIG. 8A, the box attachment member 228 is disconnected from the box 106. In one embodiment, the box attachment member 228 may be disconnected by moving the dump truck 100 forward. In an alternative embodiment, the pivoting actuator 246 is slightly retracted to move the box attachment member 228 away from the box 106. In yet another embodiment, the box attachment member 228 is manually disconnected from the box 106 by the user.

To move the dump truck 100 to a travel position, the frame actuator 204 may then be retracted to lower the front end 260 of the frame 200 towards the chassis 104. The pivoting actuator 246 may also be retracted to pivot the arm 210 forwardly towards the frame 200. When the first link member 212 abuts the stop member 240 of the frame 200, further pivoting of the first link member 212 is prevented. Further retraction of the pivoting actuator 246 then causes the second link member 220 to pivot about the arm pivot 224 towards its starting position along the frame 200.

It will be appreciated that to load the box 106 onto the dump truck 100, the steps described above may be performed in a reverse order.

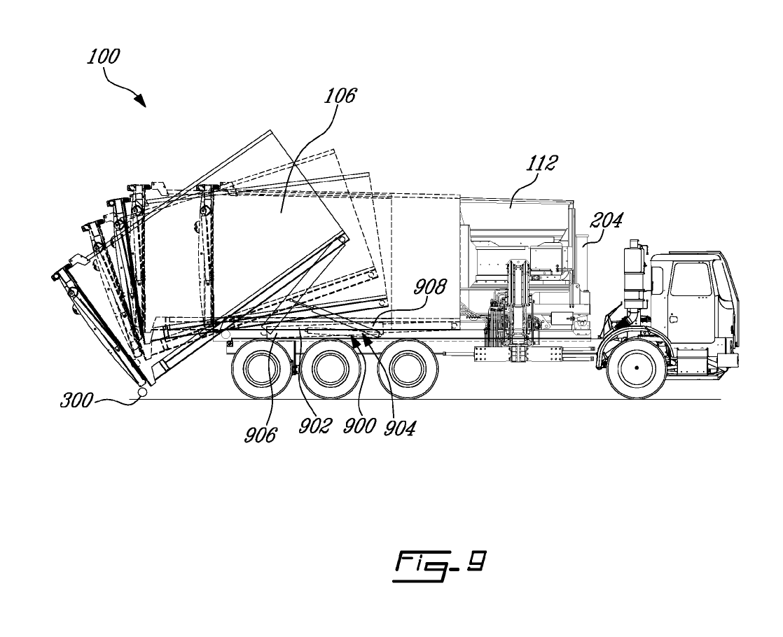

With reference to FIGS. 9 to 12, there is provided a dump truck 100 having a lifting assembly 900 which allows the box 106 to be selectively loaded onto the chassis 104 and unloaded from the chassis 104, in accordance with an alternative embodiment.

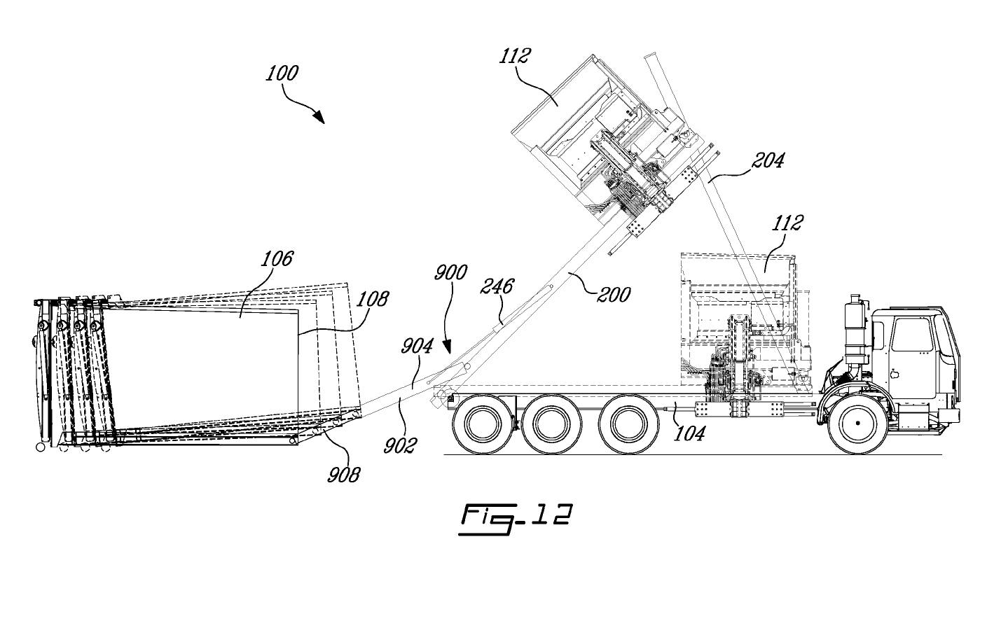

The lifting assembly 900 is substantially similar to the lifting assembly 150 shown in FIGS. 1 to 8A, except that in this embodiment, the arm 210 comprises a single arm member 902 pivotably connected to the frame. More specifically, the arm member 902 comprises an arm actuator 904 having an actuator sleeve 906 pivotably connected to the frame 200 and an elongated inner member 908, best shown in FIG. 12, telescopically movable relative to the actuator sleeve 906 and releasably attached to the box 106. Still in this embodiment, the pivoting actuator 246 is pivotably connected to the frame 200 and to the actuator sleeve 906 of the arm member 902.

The operation of unloading the box 106 from the dump truck 100 using the lifting assembly 900 will now be described.

In a starting or transport position, the frame actuator 204 and the pivoting actuator 246 are in a retracted position. The arm 210 is positioned along the frame 200 in the unfolded position, with the elongated inner member 908 located near the hopper 112. The arm actuator 904 is in an extended position such that the box 106 is positioned adjacent the hopper 112.

According to one step illustrated in FIG. 9, the connecting device 234 is disconnected to release the box 106 from the hopper 112. The arm actuator 904 is then retracted to move the box 106 rearwardly, away from the hopper 112. For example, in one embodiment, the box 106 is moved rearwardly by a distance of 48 inches. It will be understood that the actual distance by which the box is moved depends on the specific design of the embodiment and is non-limiting. The pivoting actuator 246 is then extended to pivot the arm member 902 rearwardly, away from the frame 200, thereby pivoting the box 106 rearwardly until the plurality of wheels 300 of the box 106 contacts the ground surface.

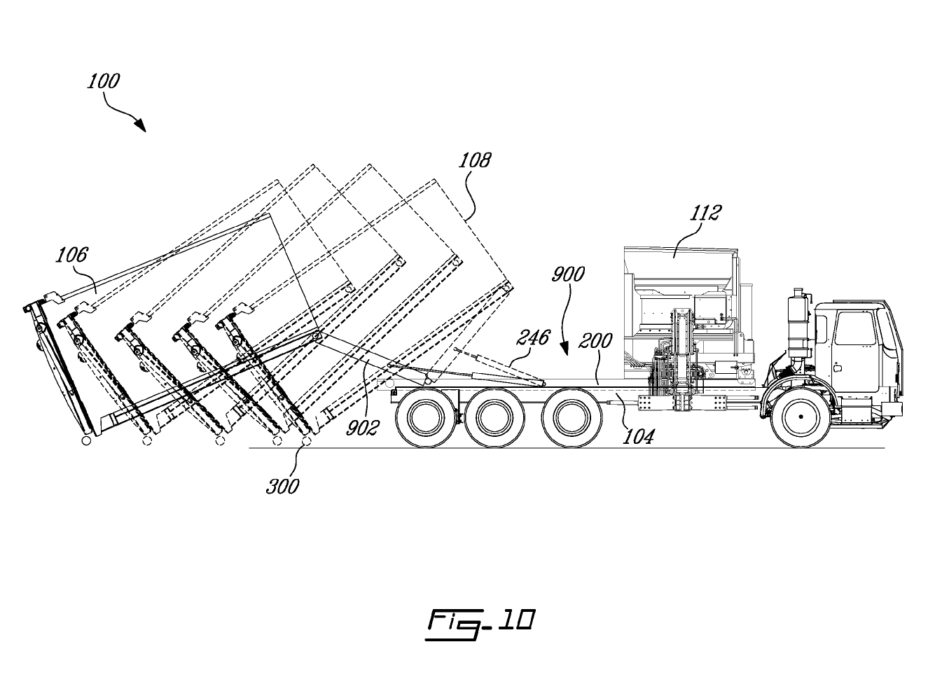

According to another step illustrated in FIG. 10, the pivoting actuator 246 is further extended to further pivot the arm member 902. Since the plurality of wheels 300 contact the ground, the box 106 is prevented from further pivoting and instead is moved rearwardly away from the chassis 104. The arm member 902 is pivoted in this manner until the pivoting actuator 246 is fully extended to position the front end 108 of the box 106 rearwardly of the frame 200, such that the frame 200 is no longer under the box 106. In the illustrated embodiment, when the pivoting actuator 246 is fully extended, the arm member 902 is slightly angled upwardly relative to the frame 200.

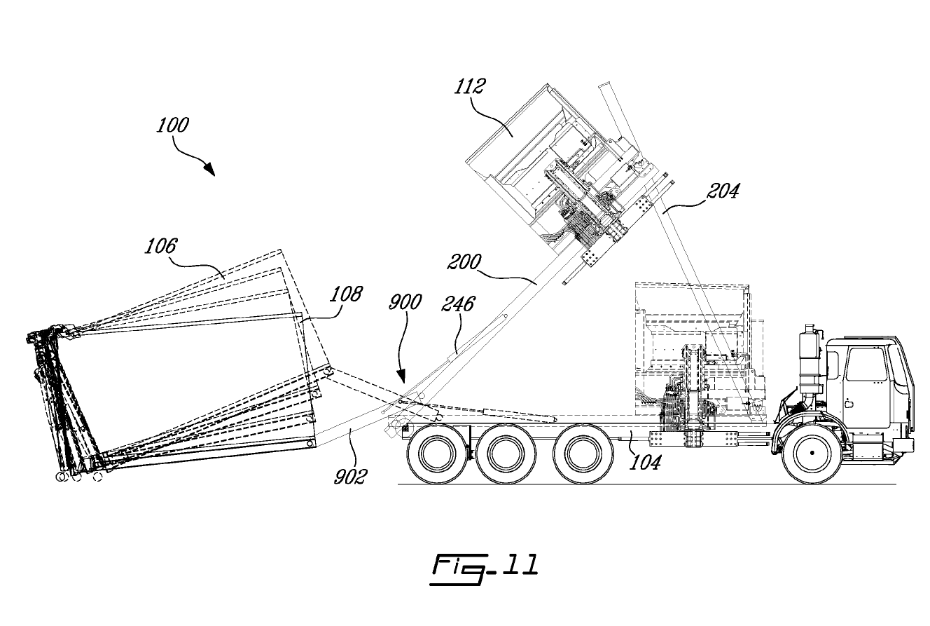

According to yet another step illustrated in FIG. 11, the frame actuator 204 is extended to tilt the frame 200 rearwardly. By doing so, the arm member 902 further pivots rearwardly relative to the chassis 104 and the front end 108 of the box 106 is moved downwardly towards the ground surface. As shown in FIG. 11, the arm member 902 is also oriented downwardly towards the ground surface in this step.

According to yet another step illustrated in FIG. 12, the arm actuator 904 is then extended until the front end 108 of the box 106 contacts or abuts the ground surface such that the box 106 rests on the ground surface, generally horizontally. The box attachment member 228 may then be detached from the box 106 as described above.

It will be appreciated that to load the box 106 onto the dump truck 100, the steps described above may be performed in a reverse order.

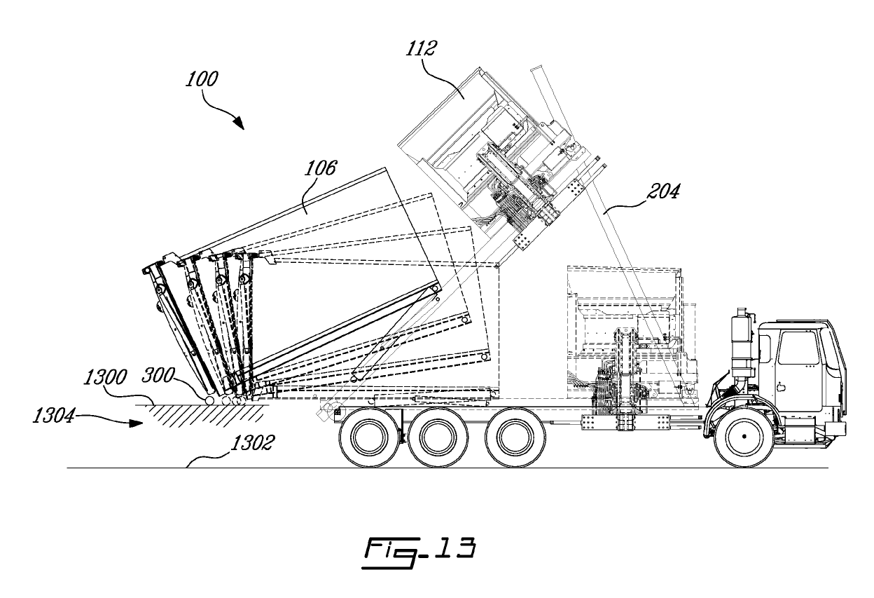

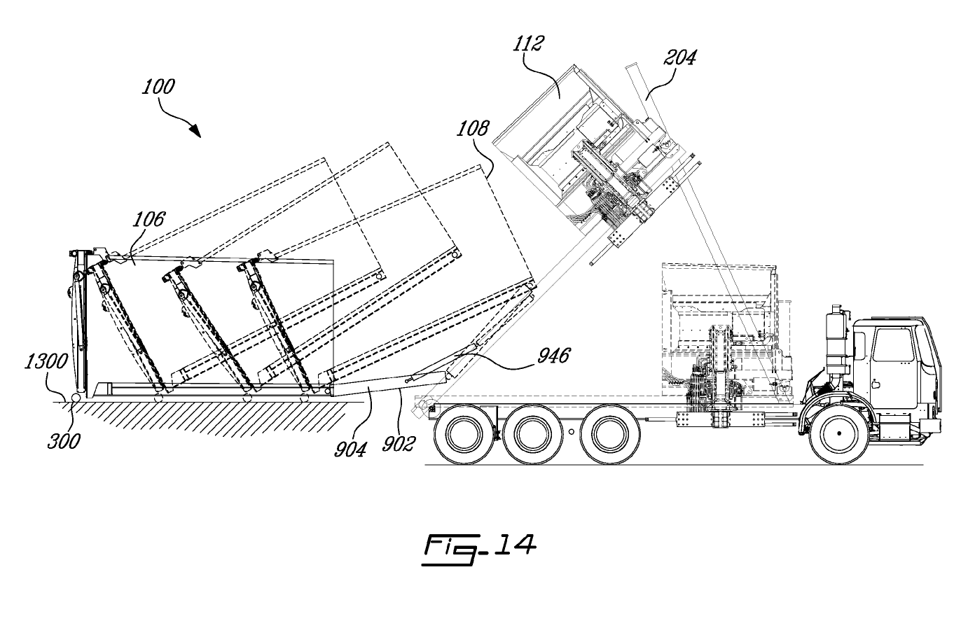

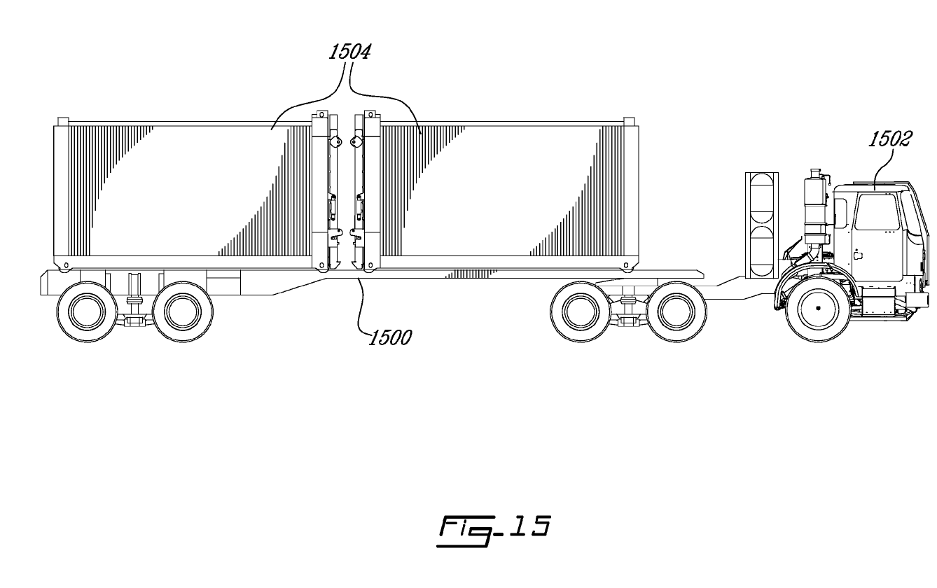

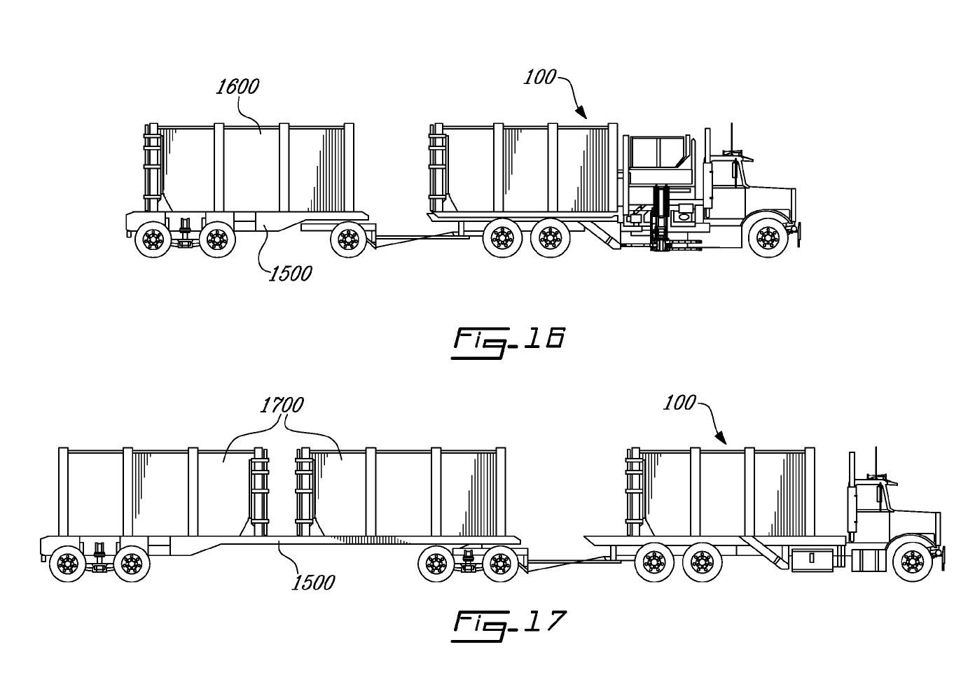

With reference to FIGS. 13 and 14, the operation of unloading the box 106 from the dump truck 100 using the lifting assembly 900 will now be described, in accordance with an alternative embodiment. In this embodiment, the box 106 is unloaded onto a receiving surface 1300 which is located higher than the ground surface 1302, generally at the same level as the chassis 104. In one embodiment, the receiving surface 1300 is a trailer 1304 adapted to receive one or more boxes, such as the flat-bed semi-trailer 1500 shown in FIG. 15. In such an embodiment, the trailer 1500 may then be attached to a tractor unit 1502 to allow a plurality of boxes 1504 to be transported at once. Alternatively, the trailer 1500 may be directly attached to the dump truck 100, and may be adapted to carry a single box 1600, as shown in FIG. 16, or a plurality of boxes 1700, as shown in FIG. 17. In yet another embodiment, the receiving surface may instead be an immobile elevated surface such as a loading dock.

According to one step illustrated in FIG. 13, from the transport position, the arm actuator 904 is retracted to move the box 106 rearwardly, away from the hopper 112. In one embodiment, the box 106 is moved rearwardly. For example, the box could be moved rearwardly by a distance of 48 inches. It will be understood that the actual distance by which the box is moved depends on the specific design of the embodiment and is non-limiting. The frame actuator 204 is then extended to tilt the frame 200 rearwardly. In this position, the plurality of wheels 300 of the box 106 contacts the receiving surface 1300.

According to another step illustrated in FIG. 14, the pivoting actuator 246 is then extended to pivot the arm member 902 rearwardly, thereby moving the front end 108 of the box 106 towards the receiving surface 1300 until the box 106 rests on the receiving surface 1300. The box attachment member 228 may then be detached from the box 106 as described above.

It will be appreciated that to load the box 106 onto the dump truck 100, the steps described above may be performed in a reverse order.

It will be appreciated that the lifting assembly described above allows the box to be completely removed from the dump truck, while still allowing the box to be tilted rearwardly to enable the dump truck to perform as a regular dump truck.

It will be appreciated that the sequences of steps listed above could be modified to change the order of the steps and/or to add and/or remove steps, depending on the specific design of the embodiment and on the choice of components.

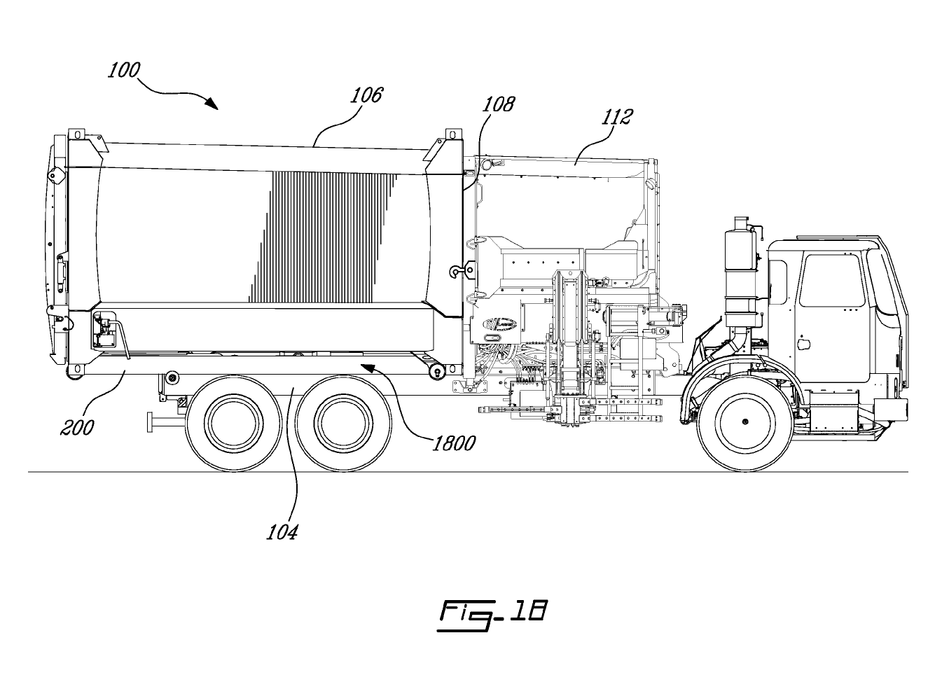

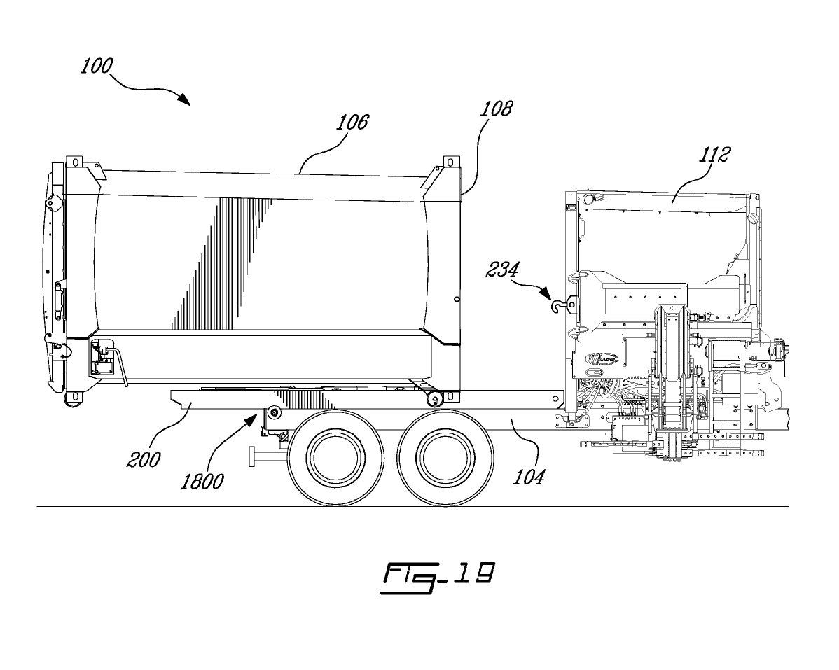

Now referring to FIGS. 18 to 25, there is provided a dump truck 100 having a lifting assembly 1800 which allows the box 106 to be selectively loaded onto the chassis 104 and unloaded from the chassis 104, in accordance with yet another embodiment.

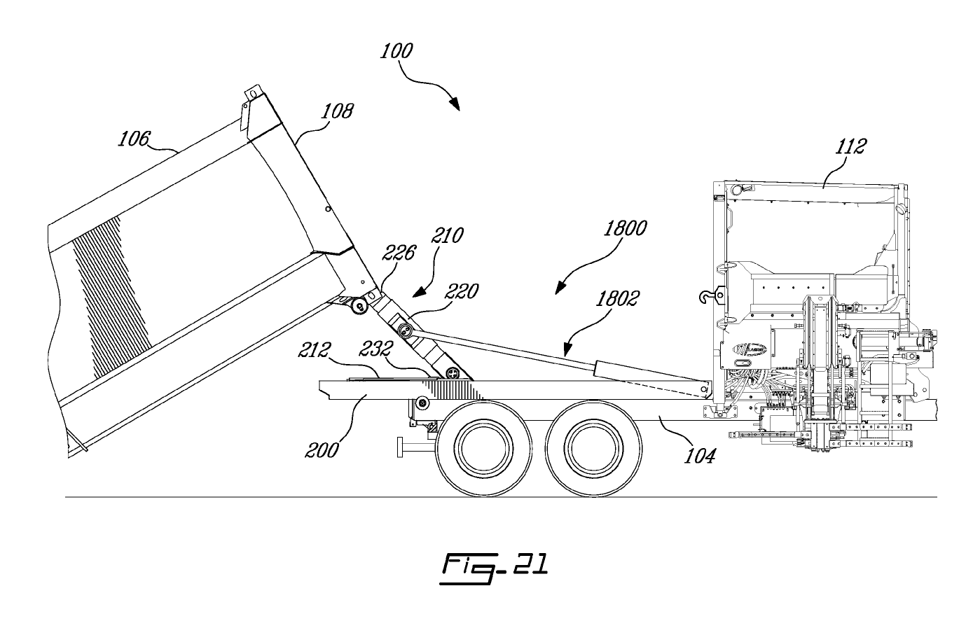

This embodiment is substantially similar to the embodiment shown in FIGS. 1 to 8A, except that in the present embodiment, the frame 200 is secured to the chassis 104 of the dump truck 100 and is not tilted. It could still be tiltable but in the sequence of steps which will now be described, it is not tilted. The frame 200 may even be part of the dump truck 100 and be integrally formed with the chassis 104. Accordingly, in this embodiment, the lifting assembly 1800 does not necessitate a frame actuator. Instead, the lifting assembly 1800 comprises a pivoting actuator 1802, best shown in FIG. 20, which is extended substantially further rearwardly than the pivoting actuator 246 shown in FIGS. 1 to 8A during operation of the lifting assembly 1800. This allows the arm 210 to still be pivoted such that the second end 226 of the second link member 220 is located rearwardly of the frame 200 and is oriented towards the ground surface.

The operation of unloading the box 106 from the dump truck 100 using the lifting assembly 1800 will now be described.

FIG. 18 shows the lifting assembly 1800 in a starting or transport position, similar to the position shown in FIG. 1. In this position, the arm 210 is in the unfolded position, described above.

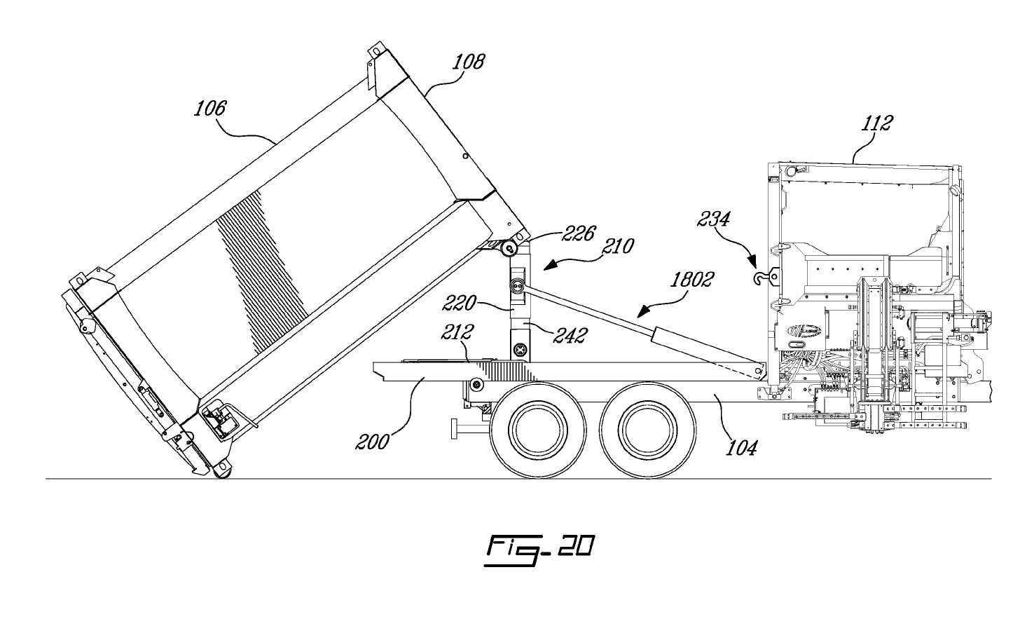

According to one step shown in FIG. 19, the connecting device 234 is disconnected to release the box 106 from the hopper 112. The arm actuator 242 is then retracted to move the box 106 rearwardly, away from the hopper 112.

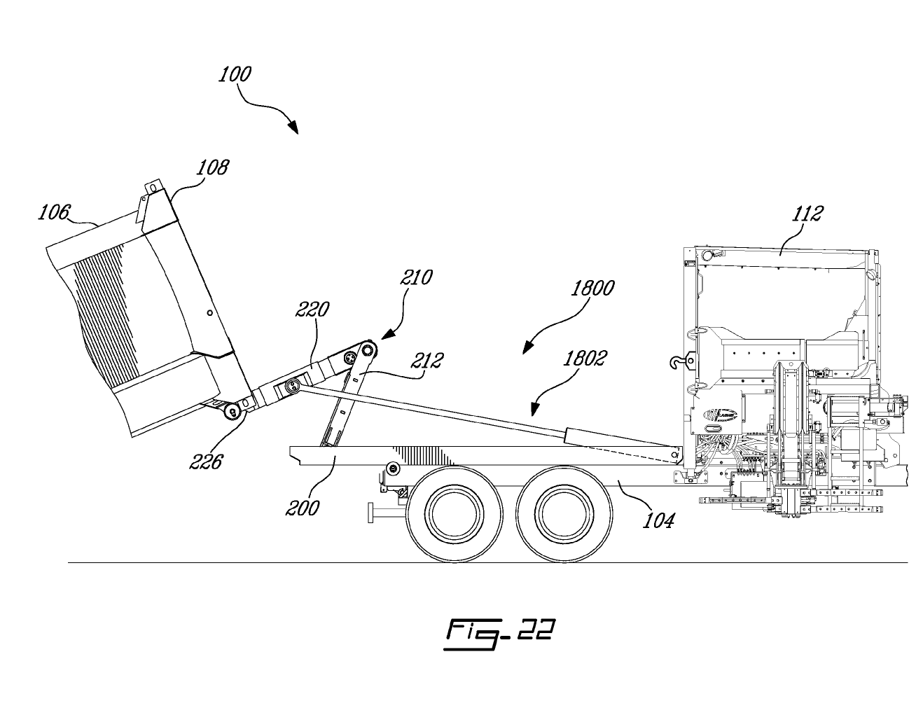

According to another step shown in FIGS. 20 and 21, the pivoting actuator 1802 is extended to pivot the second link member 220 rearwardly relative to the first link member 212, until the second link member 220 abuts the abutment portion 232 of the first link member 212.

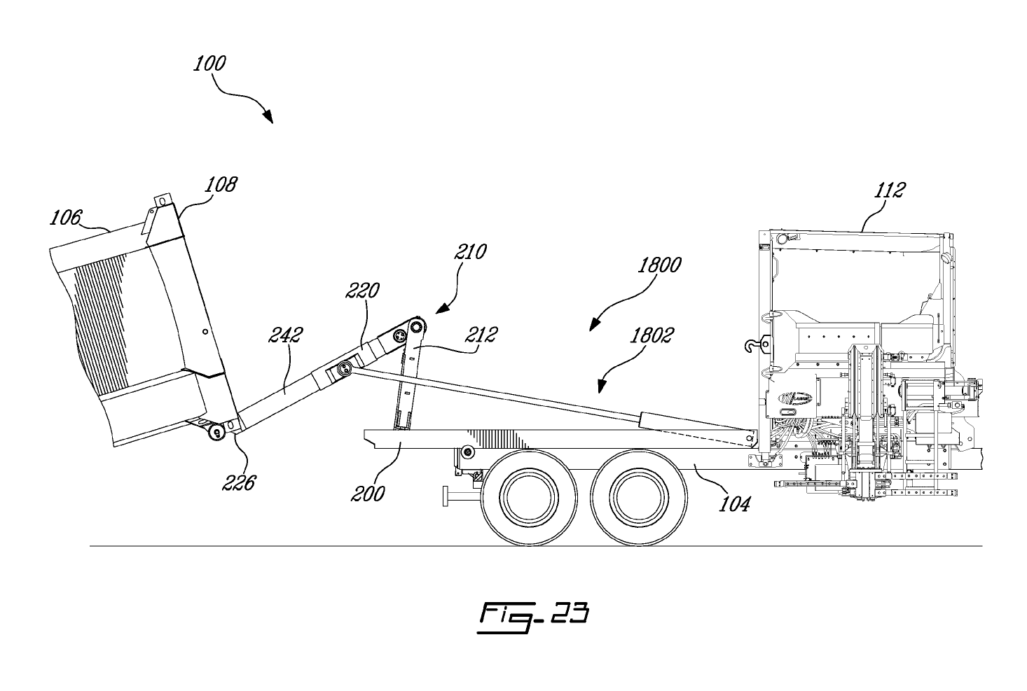

According to another step shown in FIG. 22, the pivoting actuator 1802 is further extended to pivot the first link member 212 of the arm 210 rearwardly, away from the frame 200, to position the second end 226 of the second link member 220 rearwardly of the frame 200 such that the frame 200 is no longer under the box 106. In the configuration illustrated in FIG. 22, the second end 226 of the second link member 220 is also oriented towards the ground surface.

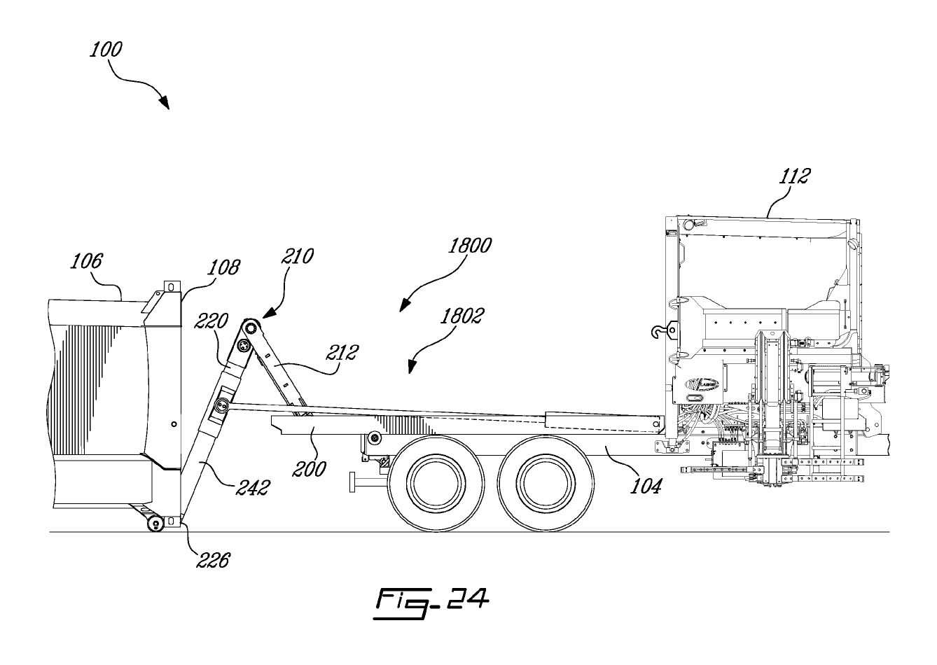

According to another step illustrated in FIG. 23, the arm actuator 242 is then extended to further move the box 106 rearwardly, away from the frame 200.

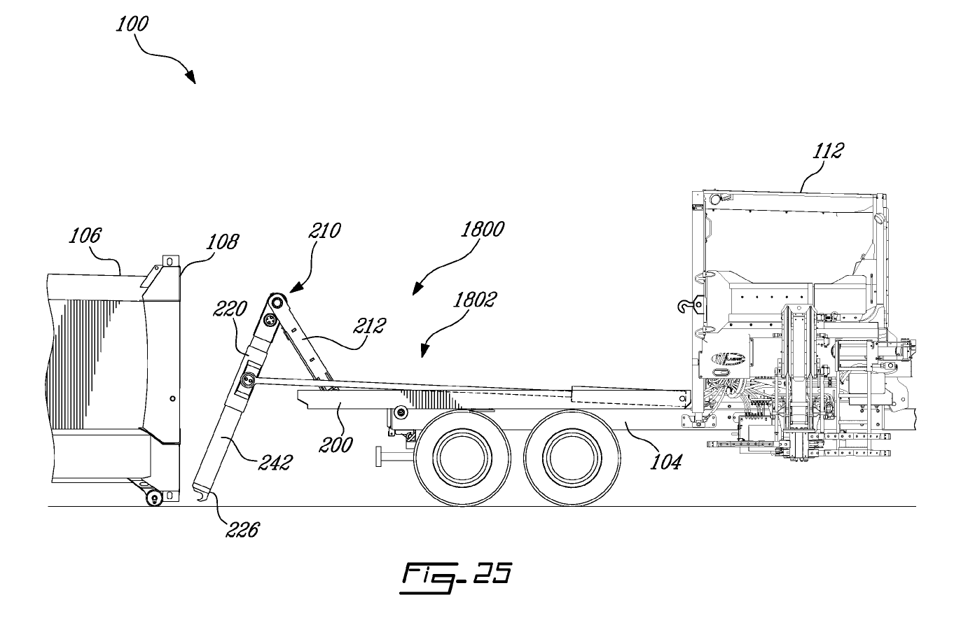

According to another step illustrated in FIG. 24, the pivoting actuator 1802 is further extended until the front end 108 of the box 106 abuts the ground surface.

Alternatively, the pivoting actuator 1802 may instead be fully extended, in the position shown in FIG. 24, before the arm actuator 242 is extended to lower the front end 108 of the box 106 until the front end 108 of the box 106 abuts the ground surface.

In yet another embodiment, the arm actuator 242 and the pivoting actuator 1802 are extended simultaneously to simultaneously move the box 1066 rearwardly and lower the front end 108 of the box 106 towards the ground surface.

According to another step illustrated in FIG. 25, the box 106 is then released from the arm 210.

A person skilled in the art will further appreciate that the lifting assembly and the dump truck may alternatively be configured according to various other embodiments. For instance, the lifting assembly may alternatively be used on other types of cargo-carrying vehicles besides dump trucks, such as pick-up trucks or the like.

Although the above description relates to a specific preferred embodiment as presently contemplated by the inventor, it will be understood that the invention in its broad aspect includes mechanical and functional equivalents of the elements described herein.

The embodiments described above are intended to be exemplary only. The scope of the invention is therefore intended to be limited solely by the appended claims.

1. A lifting assembly for selectively loading a container onto a chassis of a vehicle and unloading the container from the chassis, the lifting assembly comprising:
a frame connected to the chassis;
an arm having a first end pivotably connected to the frame and a second end releasably connectable to the container; and
a pivoting actuator having a first actuator portion pivotably connected to the frame and a second actuator portion pivotably connected to the arm between the first and second ends thereof, the second actuator portion being linearly movable relative to the first actuator portion for pivoting the arm relative to the frame to selectively move the container towards the frame and away from the frame.

2. The lifting assembly as claimed in claim 1, wherein the frame is pivotably connected to the chassis.

3. The lifting assembly as claimed in claim 2, further comprising a frame actuator pivotably connected to the chassis and to the frame for tilting the frame rearwardly relative to the chassis.

4. The lifting assembly as claimed in claim 1, wherein the arm comprises an arm actuator having a first actuator portion located near the first end of the arm and a second actuator portion located near the second end of the arm, the first actuator portion being movable relative to the second actuator portion to allow the container to be selectively moved frontwardly and rearwardly relative to the frame.

5. The lifting assembly as claimed in claim 4, wherein the arm actuator is a linear actuator.

6. The lifting assembly as claimed in claim 5, wherein the arm actuator is a hydraulic cylinder.

7. The lifting assembly as claimed in any one of claims 1 to 6, wherein the arm comprises:
a first link member pivotably connected to the frame; and
a second link member pivotably connected to the first link member, the second link member being releasably connected to a front end of the container.

8. The lifting assembly as claimed in claim 7, wherein the arm is movable between a folded position wherein the second link member is pivoted rearwardly relative to the first link member to form an angle therewith, and an unfolded position wherein the second link member is parallel to the first link member.

9. The lifting assembly as claimed in claim 8, wherein the first link member is pivotable rearwardly relative to the frame to enable locating the second end of the arm rearwardly of the frame and orienting the second end of the arm towards a ground surface when the arm is in the folded position.

10. The lifting assembly as claimed in claim 9, wherein the second link member is extendable for placing the front end of the container on the ground surface when the second end of the arm is located rearwardly of the frame and oriented towards the ground.

11. The lifting assembly as claimed in claim 1, wherein the pivoting actuator is a linear actuator.

12. The lifting assembly as claimed in claim 11, wherein the pivoting actuator is a hydraulic cylinder.

13. A cargo-carrying vehicle comprising:
a container;
a chassis for receiving the container thereon; and
a lifting assembly for selectively loading the container onto the chassis and unloading the container from the chassis, the lifting assembly including:
a frame connected to the chassis;
an arm having a first end pivotably connected to the frame and a second end releasably connected to the container; and
a pivoting actuator having a first actuator portion pivotably connected to the frame and a second actuator portion pivotably connected to the arm between the first and second ends thereof, the second actuator portion being linearly movable relative to the first actuator portion for pivoting the arm relative to the frame to selectively move the container towards the frame and away from the frame.

14. The vehicle as claimed in claim 13, wherein the frame is pivotably connected to the chassis.

15. The vehicle as claimed in claim 14, further comprising a frame actuator pivotably connected to the chassis and to the frame for tilting the frame rearwardly relative to the chassis.

16. A method for unloading a container mounted on a chassis of a vehicle from the vehicle, the method comprising:
providing a lifting assembly comprising a frame connected to the chassis for supporting the container, and an arm having a first end pivotably connected to the frame and a second end releasably connected to a front end of the container;
moving the container rearwardly to locate a rear end of the container rearwardly from the frame;
pivoting the arm rearwardly until the front end of the container is located rearwardly from the frame;
releasing the container from the arm.

17. The method as claimed in claim 16, wherein the arm comprises:
a first link member pivotably connected to the frame; and
a second link member pivotably connected to the first link member, the second link member being releasably connected to a front end of the container.

18. The method as claimed in claim 17 further comprising:
after pivoting the arm rearwardly, extending the second link member until the front end of the container abuts a ground surface.

19. The method as claimed in claim 17, wherein moving the container rearwardly comprises:
placing the arm in an unfolded position wherein the second link member is parallel to the first link member and to the frame;
retracting the second link member.

20. The method as claimed in claim 16, wherein the frame is pivotably connected to the chassis, and wherein the method further comprises:
tilting the frame rearwardly relative to the chassis to tilt the container rearwardly.
